(19) United States
(12) Patent Application Publication
(10) Pub. No.: US 2025/0020006 A1
(43) Pub. Date: Jan. 16, 2025

(54) DOOR BARACADE SYSTEM AND METHOD THEREFOR

(71) Applicant: Gilbert Cyphert, Scottsdale, AZ (US)

(72) Inventor: Gilbert Cyphert, Scottsdale, AZ (US)

(21) Appl. No.: 18/220,717

(22) Filed: Jul. 11, 2023

(51) Int. Cl. E05C 19/00; G01C 9/28

(52) U.S. Cl. CPC E05C 19/003; G01C 9/28

(57) ABSTRACT

A door barricade system has a door barricade. A mechanism for installing the door barricade is provided. The mechanism for installing the door barricade has a base having an opening for locating a drill hole for installing the door barricade. An arm member extends from the base for maintaining a horizontal level of the door barricade.

### TECHNICAL FIELD

The present application generally relates to the door locks, and, more specifically to a systema and method for installing a door barricade system.

### BACKGROUND

Presently, most residential doors have one or more door locks for safety. These door locks generally take the form of a key actuated bolt, with a keyhole located on the outside of the door. Alternately, some key actuated bolts have a keyhole located on both sides of the door. To move the bolt, a key may be inserted in the keyhole at one side of the door. The key may be rotated either clockwise or counterclockwise to lock or unlock the door. The key may then be removed.

While key actuated bolts do work, there are some issues with them. First, the key has to be inserted in the keyhole and actuated. In case of poor lighting at either side of the door, the insertion of the key can be difficult. Second, it is often easy for thieves and robbers to break through a conventional bolt lock mechanism because the bolt of the lock mechanism generally only extends an inch or less into a portion of the door frame. Further, installing a key actuated bolt can be difficult and generally requires someone with installation experience as well as specialized tools.

Therefore, it would be desirable to provide a system and method that overcomes the above. The system and method would allow for the installation of a door barricade device to be installed on a door. The system and method would allow for the installation of a door barricade device to be installed on a door, wherein the door barricade device has an elongated bar with a hook portion that engages a hasp assembly.

### SUMMARY

In accordance with one embodiment, a door barricade system is disclosed. The system has a door barricade. A mechanism for installing the door barricade is provided, wherein the mechanism for installing the door barricade has a base having an opening. The opening is used for locating a drill hole for installing the door barricade system. An arm member extends from the base and is used for maintaining a horizontal level of the door barricade system.

In accordance with one embodiment, a door barricade system is disclosed. The door barricade system has a base having an opening located in a center area of the base. The opening is used for locating a drill hole for installing a door barricade. An arm member extends from the base and is used for maintaining a horizontal level of the door barricade. A slot runs horizontally down a length of the arm member.

In accordance with one embodiment, a door barricade system is disclosed. The door barricade system has a door barricade. A base is provided and has an opening located in a center area. The opening is used to locate a drill hole for installing the door barricade. An arm member extends from the base for maintaining a horizontal level of the door barricade. A slot runs horizontally down a length of the arm member. A clamp is attached to a distal end of the arm member and across the slot. A level is attached to a top area of the clamp.

### BRIEF DESCRIPTION OF THE DRAWINGS

The present application is further detailed with respect to the following drawings. These figures are not intended to limit the scope of the present invention but rather illustrate certain attributes thereof.

FIG. 1 is a perspective view of an exemplary system for installing a door barricade in accordance with one aspect of the present application;

FIG. 2 is a first perspective view of the exemplary system for installing a door barricade in accordance with one aspect of the present application;

FIG. 3 is a second perspective view of the exemplary system for installing a door barricade in accordance with one aspect of the present application; and

FIG. 4 is a perspective view of an exemplary embodiment of an elongated pin member of the door barricade in accordance with one aspect of the present application.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary system and method relate to a mechanism for installing a door barricade, more specifically, a door barricade having an elongated bar with a hook portion that engages a hasp assembly. The mechanism may be a muti-piece jig to be used for aiding in the installation of the door barricade. The multi-piece jig may have an attachment mechanism that secures the multipiece jig to the elongated bar of the door barricade and that may ensure that the elongated bar of the door barricade is level for installation. The multi-piece jig may have a drill hole template for locating a position of a drill hole for the door barricade.

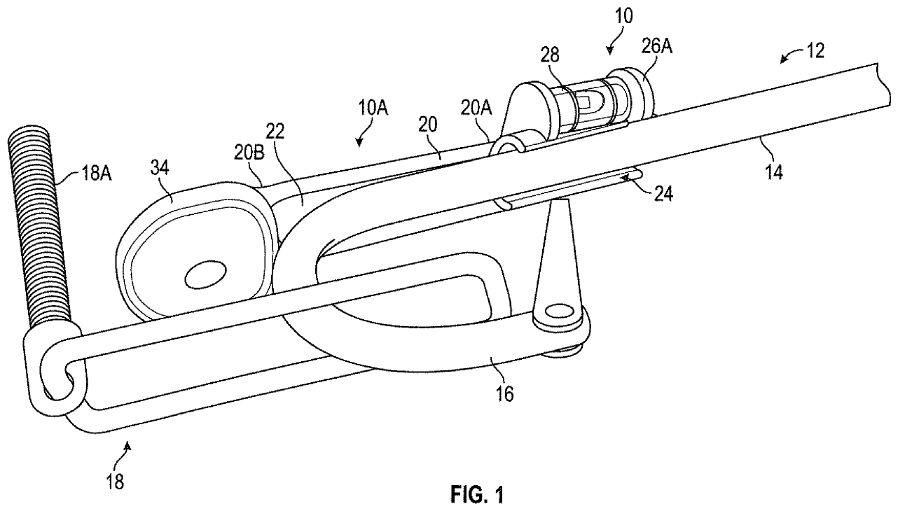

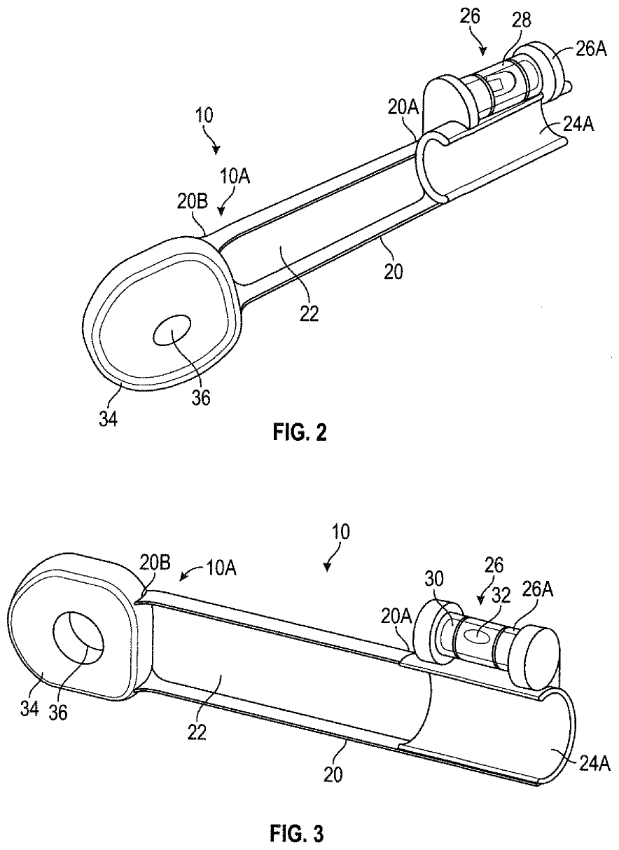

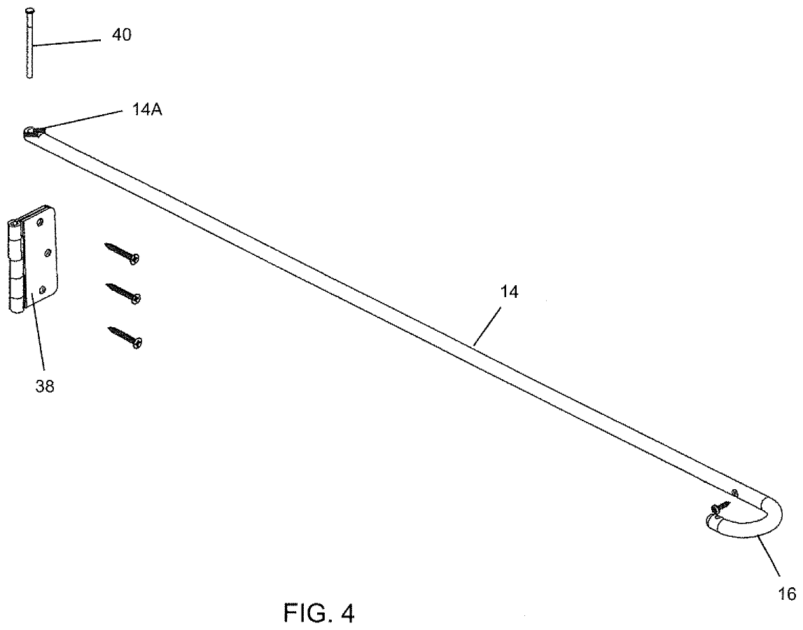

Referring to FIGS. 1-3, a door barricade system 1 may be shown. The door barricade system 1 may include a mechanism 10 for installing a door barricade 12. In the present embodiment, the mechanism 10 may be used to install a door barricade 12 having an elongated bar 14. A hook portion 16 may be formed on one end of the elongated bar 14. The hook portion 16 may be used to engage a hasp assembly 18. In accordance with one embodiment, the hook portion 16 may be a snap on clamp. As may be shown in FIG. 4, located at a distal end of the elongated bar 14 may be an opening 14A drilled through the elongated bar 14. The opening 14A may allow the elongated bar 14 to be secured to a door hinge 38 of a door to which the door barricade 12 may be installed. In accordance with one embodiment, a hinge pin 40 of the door hinge 38 may be used to secure the elongated bar 14 to the door hinge 38.

The mechanism 10 may be formed of a multi-piece jig 10A that may attach to the elongated bar 14 of the door barricade 12. The multi-piece jig 10A may be formed as a single unit or multiple pieces attached together. The multi-piece jig 10A may be formed of a lightweight but sturdy material such as a hardened plastic, aluminum, or similar materials.

The multi-piece jig 10A may have a bar member 20. A slot 22 may be formed horizontally down the bar member 20. In accordance with one embodiment, the slot 22 may run horizontally along a length of the bar member 20. Located at a distal end 20A of the bar member 20 is a clip 24. In the present embodiment, the clip 24 may be a “U” shaped clip 24A which extends across the slot 22. A bottom section of the “U” shaped clip 24A may be set back from the slot 22.

Attached to a top section of the “U” shaped clip 24A may be a leveler 26. In accordance with one embodiment, the leveler 26 may be detachable so that the leveler 26 may be removed from the bar member 20. The leveler 26 may be used to establish that the bar member 20 is on a horizontal plane. In accordance with one embodiment, the leveler 26 may be a bubble level 26A. The bubble level 26A may consist of a small glass tube 28 containing alcohol or similar liquid 30 and an air bubble 32.

Located at a proximate end 20B of the bar member 20 may be a base 34. The base 34 may be any geometrical configuration. In the present embodiment, the base 34 is circular in shape. However, this is shown as an example and should not be seen in a limiting manner as the base 34 may take on other geometrical configurations.

Located in a center area of the base 34 may be a hole 36. The hole 36 may extend through the base 34. The hole 36 may be used as a template for locating a drill hole for installation of the door barricade device 12.

In operation, the mechanism 10 may be removably attached to the door barricade 12. The mechanism 10 may be positioned behind the elongated bar 14 with the hook portion 16 so that the elongated bar 14 slides within the slot 22 and into the clip 24, with the clip 24 securing the elongated bar 14 within the mechanism 10. Using the level device 26, the user may ensure that the bar member 20 is on a horizontal plane. The user may then use the hole 36 in the base 34 to mark/drill a hole for installation of the hasp assembly 18. The hole formed may be used to secure an anchor pin 18A of the hasp assembly 18. In accordance with one embodiment, the anchor pin 18A may be threaded wherein the threading may be used to secure the anchor pin 18A into a frame of the door. In accordance with one embodiment, the system 1 may include a drill bit. Including a drill bit may ensure that the installer does not make a mistake on the size and/or depth of the hole to be drilled.

The foregoing description is illustrative of particular embodiments of the invention, but is not meant to be a limitation upon the practice thereof. The following claims, including all equivalents thereof, are intended to define the scope of the invention.

What is claimed is:

1. A door barricade system, comprising:
a door barricade; and
a mechanism for installing the door barricade, wherein the mechanism for installing the door barricade comprises:
a base having an opening for locating a drill hole for installing the door barricade; and
an arm member extending from the base for maintaining a horizontal level of the door barricade.

2. The door barricade system of claim 1, comprising a slot formed horizontally down a length of the arm member.

3. The door barricade system of claim 1, comprising a clamp attached to a distal end of the arm member.

4. The door barricade system of claim 1, comprising a level attached to a distal end of the arm member.

5. The door barricade system of claim 1, comprising:
a clamp attached to a distal end of the arm member; and
a level removably attached to the clamp.

6. The door barricade system of claim 1, comprising:
a slot formed horizontally down a length of the arm member; and
a clamp coupled to a distal end of the arm member, the clamp extending across the slot.

7. The door barricade system of claim 6, wherein the clamp is a “U” shaped clamp, a bottom section of the “U” shaped clamp extends behind the arm member.

8. The door barricade system of claim 6, comprising a level attached to the clamp.

9. the door barricade device of claim 1, wherein the door barricade device comprises:
an elongated bar having a first end secured to a hinge and a hook formed on the second end;
a hasp assembly engaging the hook of the elongated bar.

10. A door barricade system, comprising:
a base having an opening located in a center area of the base, the opening locating a drill hole for installing a door barricade;
an arm member extending from the base for maintaining a horizontal level of the door barricade; and
a slot running horizontally down a length of the arm member.

11. The door barricade system of claim 10, comprising a clamp attached to a distal end of the arm member and across the slot.

12. The door barricade system of claim 11, wherein the clamp is a “U” shaped clamp, a bottom section of the “U” shaped clamp extends behind the arm member.

13. The door barricade system of claim 10, comprising a level attached to a distal end of the arm member.

14. The door barricade system of claim 10, comprising a level removably attached to the clamp.

15. The device for installing a door barricade system of claim 10, wherein the door barricade device comprises:
an elongated bar having a first end secured to a hinge and a hook formed on the second end;
a hasp assembly engaging the hook of the elongated bar.

16. A door barricade system, comprising:
a door barricade;
a base having an opening located in a center area of the base, the opening locating a drill hole for installing the door barricade;
an arm member extending from the base for maintaining a horizontal level of the door barricade;
a slot running down horizontally along a length of the arm member;
a clamp attached to a distal end of the arm member and across the slot; and
a level attached to a top area of the clamp.

17. The door barricade system of claim 16, wherein the clamp is a “U” shaped clamp, a bottom section of the “U” shaped clamp extends behind the arm member.

18. The door barricade system of claim 16, wherein the level is a bubble level.

19. The door barricade system of claim 16, wherein the level is removably attached to the clamp.

20. The door barricade system of claim 16, wherein the door barricade device comprises:
an elongated bar having a first end secured to a hinge and a hook formed on the second end;
a hasp assembly engaging the hook portion of the elongated bar.
